(19) United States
(12) Patent Application Publication
(10) Pub. No.: US 2026/0057108 A1
(43) Pub. Date: Feb. 26, 2026

(54) VEHICLE BASED ANONYMIZATION OF LOCALIZATION VEHICLE DATA

(71) Applicant: Ford Global Technologies, LLC, Dearborn, MI (US)

(72) Inventors: David Michael Herman, West Bloomfield, MI (US); Yashanshu Jain, Dearborn, MI (US)

(21) Appl. No.: 18/815,254

(22) Filed: Aug. 26, 2024

(51) Int. Cl. G06F 21/62; H04L 9/40

(52) U.S. Cl. CPC G06F 21/6254; H04L 63/0421; G06F 2221/2111

(57) ABSTRACT

A method that includes defining delta coordinates indicative of positional relationship between a vehicle and a distinct location separate from the vehicle, converting absolute coordinates of the vehicle to ambiguous coordinates having hash coordinates associated with the distinct location and the delta coordinates, retrieving a map tile associated with the ambiguous coordinates from among a plurality of map tiles, and outputting a message including anonymized location data as a location of the vehicle and defined by the map tile and the delta coordinates.

### TECHNICAL FIELD

The present disclosure generally relates to generating and transmitting vehicle data and more specifically, generating anonymous vehicle data for transmission.

### BACKGROUND

The statements in this section merely provide background information related to the present disclosure and may not constitute prior art.

Vehicle connectivity allows a vehicle system (e.g., an advanced driver assistance system (ADAS)), to share data, such as, but not limited to, speed, heading, and/or location. The vehicle data can be employed for various applications, such as to monitor operation of the vehicle and/or update algorithms/models employed by the vehicle systems.

### SUMMARY

This section provides a general summary of the disclosure and is not a comprehensive disclosure of its full scope or all of its features.

In one form, the present disclosure is directed to a method that includes: defining, by a vehicle system, delta coordinates indicative of positional relationship between a vehicle and a distinct location separate from the vehicle; converting, by the vehicle system, absolute coordinates of the vehicle to ambiguous coordinates having hash coordinates associated with the distinct location and the delta coordinates; retrieving, by the vehicle system, a map tile associated with the ambiguous coordinates from among a plurality of map tiles; and outputting, by the vehicle system, a message including anonymized location data as a location of the vehicle and defined by the map tile and the delta coordinates.

In one form, the present disclosure is directed to a system for a vehicle. The system includes one or more computing devices configured to: define delta coordinates indicative of positional relationship between a vehicle and a distinct location separate from the vehicle, convert absolute coordinates of the vehicle to ambiguous coordinates having hash coordinates associated with the distinct location and the delta coordinates, retrieve a map tile associated with the ambiguous coordinates from among a plurality of map tiles, and output a message including anonymized location data as a location of the vehicle and defined by the map tile and the delta coordinates.

In one form, the present disclosure is directed to a method that includes: obtaining, by a vehicle system, absolute coordinates of a vehicle using at least one location signal from a satellite network; identifying, by the vehicle system, a distinct location separate from the vehicle using the absolute coordinates; defining, by the vehicle system, delta coordinates indicative of positional relationship between the vehicle and the distinct location; converting, by the vehicle system, the absolute coordinates of the vehicle to ambiguous coordinates having hash coordinates associated with the distinct location and the delta coordinate; retrieving, by the vehicle system, a map tile associated with the ambiguous coordinates from among a plurality of map tiles; and outputting, by the vehicle system, a message including anonymized location data defined by the map tile and the delta coordinates as a location of the vehicle.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

In order that the disclosure may be well understood, there will now be described various forms thereof, given by way of example, reference being made to the accompanying drawings, in which:

FIG. 1 is an example block diagram of a vehicle having a vehicle location anonymization module and an ADAS configured to communicate with an ADAS server using anonymized data;

FIG. 2 is an example flow diagram of a coordinate anonymization process of the vehicle location anonymization module; and

FIG. 3 illustrates a coordinate anonymization of absolute coordinates of the vehicle.

The drawings described herein are for illustration purposes only and are not intended to limit the scope of the present disclosure.

### DETAILED DESCRIPTION

As required, detailed embodiments are disclosed herein; however, it is to be understood that the disclosed embodiments are merely exemplary and present disclosure may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the features of the present disclosure.

Vehicle data can contain personal identifiable information such as, but not limited to, absolute location of the vehicle and/or characteristics of the road or surroundings that can be employed to identify a location of the vehicle. Collection and possible dissemination of personal identifiable information can pose challenges in view of, for example, data governance proposals and/or other policies. This may impose a challenge for obtaining data to evaluate and/or modify, for example, ADAS features.

In some applications, personal identification information may be slightly altered to protect privacy while providing high fidelity vehicle data. In a nonlimiting example, vision data, such as images having known landmarks, may be blurred to inhibit identification of the surroundings of the vehicle. However, certain data, such as absolute coordinates, provide useful information in analyzing action of a vehicle system (e.g., lane position control provided by the ADAS).

The present disclosure is directed to a system/method to provide anonymized location data of the vehicle that is employable to monitor operation of the vehicle, update algorithms/models employed by the vehicle systems, among other actions. In a non-limiting example, the system of the present disclosure translates absolute coordinates of the vehicle to ambiguous coordinates having hash coordinates associated with a distinct location unassociated with the vehicle and delta coordinates indicative of positional relationship between the vehicle and the distinct location. The system further retrieves a map tile associated with the ambiguous coordinates from among a plurality of map tiles and defines anonymized location data using the map tile and the delta coordinates, where the anonymized location data is employed as a location of the vehicle. The system/method provides anonymity by converting absolute coordinates to location data untraceable to the vehicle while providing general location information used to analyze other vehicle data related to a vehicle control (e.g., data related lane position control or other ADAS features).

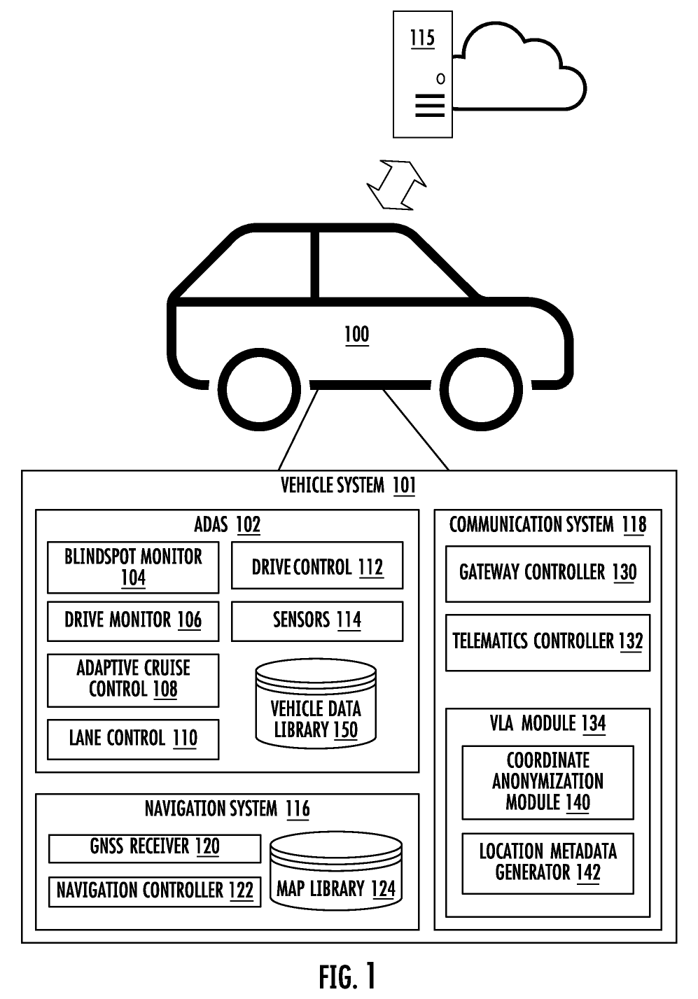

Referring to FIG. 1, in some aspects, a vehicle 100, as part of its vehicle system 101, includes an advanced driver assistance system (ADAS) 102 providing one or more drive assistance features, such as but not limited to, a blind spot monitor 104, a drive monitor 106, an adaptive cruise control 108, a lane drive control 110, and/or a drive control 112. The blind spot monitor 104 is configured to detect potential objects in a region having a blind spot (e.g., side view blind spot) and providing an alert to a driver if an object is detected (e.g., alert may include a sound and/or illumination of a light). The drive monitor 106 is configured to detect whether the vehicle 100 is departing a drive lane and/or may potentially interfere with an object ahead of the vehicle 100. The adaptive cruise control 108 is configured monitor a distance between the vehicle 100 and a lead vehicle that is ahead of the vehicle 100, and adjust a speed of the vehicle 100 to control distance between the vehicle 100 and the lead vehicle. The lane drive control 110 is configured to control a lateral position of the vehicle 100, so that the vehicle 100 stays within the drive lane along which the vehicle 100 is driving. The drive control 112 is configured to provide partial to fully autonomous control of the drive operation of the vehicle 100 to a desired location. In a non-limiting example, when available, the drive control 112 is configured to monitor surroundings and perform various drive operation such as controlling speed, changing lanes, turning, and/or following traffic lights. The various drive assistance features may be selectable by a driver and operate with or separately from one another.

The ADAS system 102 further includes one or more sensors 114 to receive information with respect to the surroundings of the vehicle 100. In non-limiting example, the sensors 114 may include one or more of cameras, ultrasonic sensors, radar systems, and/or lidar systems. The sensors 114 may be used to allow the vehicle 100 to image its surroundings. For instance, cameras may be mounted on the front, rear, and sides of the vehicle 100 to capture visual images of the surroundings of the vehicle 100. The images may be used to detect, for example, the position of pedestrians, traffic lights/signs, and/or other vehicles.

While illustrated as separate features/controls, the drive assistance features of the ADAS 102 may be implemented using one or more controllers configured to perform one or more drive assistance features (e.g., at least one of blind spot monitor 104, the drive monitor 106, the adaptive cruise control 108, the lane drive control 110, and/or the drive control 112). With increase in automation control of the vehicle 100, the ADAS 102 may be configured with advanced algorithms and/or artificial intelligence (AI) models to process data from the sensors 114 to identify and predict trajectories of moving objects and, if applicable, perform drive operations (e.g., adjusting speed, moving to a different lane, adjust lateral position of the vehicle 100 to be within the drive lane, and/or stop the vehicle, among other drive operations).

In some aspects, the ADAS 102 is configured to transmit a message to an ADAS support server 115 to share information related to one or more of the drive assistance features. In a non-limiting example, messages may be transmitted in response to an ADAS event that may include, but is not limited to: status of the drive assistance features (e.g., which features are active and which are de-active), activation/deactivation of the adaptive cruise control 108, drive operations taken to correct lane position, detection of forward interference, and/or drive operations taken to circumvent an object interference. The type of information included in the message, as vehicle data, may include, but is not limited to: location of the vehicle, heading of the vehicle, steering angle, lane position, speed setting for cruise control, data related to detected objects (classification of the object and position of the object relative to the vehicle), traffic condition, entering/exiting predefine geographic areas (e.g., geofencing alerts), image data of one or more images of the surrounding area of the vehicle 100; and/or data related to the type of maneuvers taken to circumvent interference.

In one form, the ADAS support server 115 is configured to use information from the vehicle 100 for various purposes, such as but not limited to: sharing data with other vehicles or systems (e.g., sharing information regarding vehicle location with traffic delays), training drive assist models employed for autonomous drive control; and/or train or adjust algorithms related to one or more of the drive assistance features. In a non-limiting example, the ADAS support server 115 is a provided as a remote server supported by the original manufacturer of the vehicle 100.

In addition to the ADAS system 102, the vehicle 100 further includes a navigation system 116 and a communication system 118. In one form, the navigation system 116 is configured to monitor a location of the vehicle 100 and define a travel route to a desired location that can be inputted by a user of the vehicle 100. In one form, the navigation system 116 includes a global navigation satellite system (GNSS) receiver 120, a navigation controller 122, and a map library 124 storing maps using a map tile technique in which the map tiles are of the same shape, each map tile conveys information related to a selected region, the set of map tiles define a continuous map when combined.

The GNSS receiver 120 is configured to determine a position or absolute coordinates of the vehicle 100 using one or more satellite networks, such as global positioning system (GPS), GLONASS, Galileo, Beidou and/or others. In a non-limiting example, the absolute coordinates are provided as latitude and longitude to provide a precise geographical location.

In one form, the navigation controller 122 is configured to monitor movement of the vehicle 100 to provide route guidance and real-time navigation. In a non-limiting example, using maps stored in the map library 124, the navigation controller 122 uses the absolute coordinates and movement of the vehicle 100 (e.g., heading, speed, etc.), which may be provided by the ADAS 102, to track movement of the vehicle 100. The navigation controller 122 may also receive information that may influence the travel of the vehicle 100 from external systems, such as but not limited to, traffic information from local infrastructure and/or travel information of other vehicles traveling within a communication range of the vehicle 100.

The communication system 118 is configured to provide a communication interface between the various systems of the vehicle 100 and between the vehicle 100 and external devices/systems (e.g., ADAS support server 115). In a non-limiting example, the communication system 118 includes a gateway controller 130, a telematics controller 132 (e.g., a telematics control unit (TCU)), and a vehicle location anonymization (VLA) module 134.

The gateway controller 130 may be configured to provide an electrical interface between vehicle communication buses used to communicate within the vehicle 100. In an example, the gateway controller 130 may be configured to route signals from one vehicle bus to another vehicle bus within the vehicle 100. The gateway controller 130 may accordingly allow the different components of the vehicle 100 to communicate, despite the components being connected to in different ways and to different buses.

The telematics controller 132 allows the vehicle 100 to communicate with remote devices over one or more communication networks. In a non-limiting example, the telematics controller 132 is configured to: track vehicle location; allow remote diagnostics of the vehicle 100; exchange messages with other vehicle or devices as part of vehicle-to-everything (V2X) communication in which the vehicle 100 shares information related to the vehicle 100, such as speed, heading, and anonymized location data; outputs signals indicating assistance may be needed at the vehicle 100 due to, for example, an object interfering with the vehicle 100. In some forms, the telematics controller 132 may include an antenna system supporting one or more communication technologies, a GNSS receiver, cellular modem, a BLUETOOTH/WI-FI type module for short range communication, a microprocessor, and/or memory storing software applications, among other communication devices.

While sharing information to external systems (e.g., the ADAS support server 115) is beneficial and at times necessary per various standards (e.g., V2X), the VLA module 134 is configured provide anonymity of the vehicle 100 and specifically, to the location of the vehicle 100 provided in the message. In one form, the VLA module 134 is configured to define an anonymized location data that provides a defined geographical area (e.g., a map tile) that the vehicle 100 is traveling in. That is, in lieu of the absolute coordinates of the vehicle 100, the VLA module 134 is configured to information related to a larger general area associated with the surroundings of the vehicle 100, so at to provide anonymity without withholding information employed for the enhancement of the ADAS 102.

In one form, the VLA module 134 includes a coordinate anonymization module 140 and a location metadata generator 142.

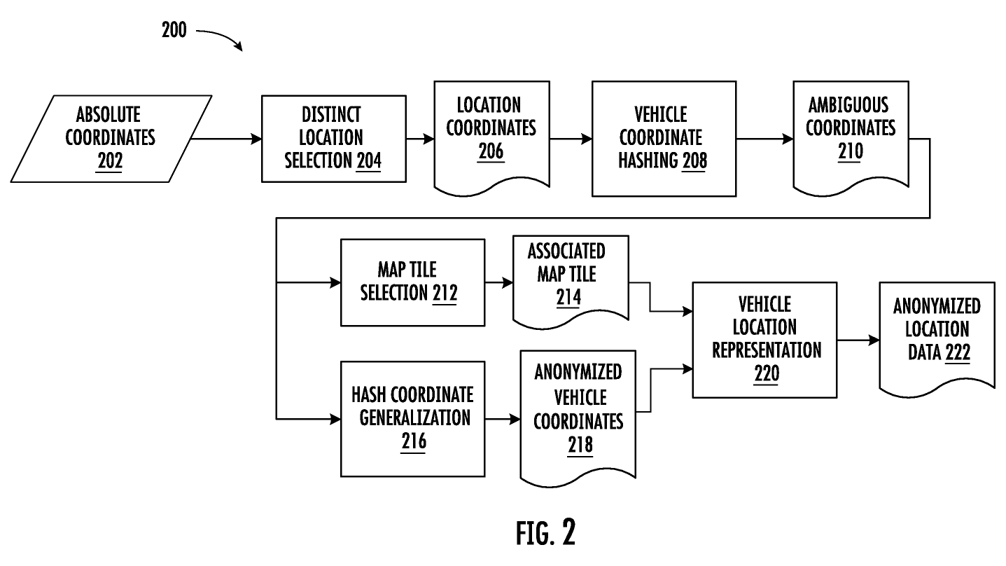

The coordinate anonymization module 140 is configured to translate or convert the absolute coordinates of the vehicle 100 to location information unassociated with the vehicle 100. Referring to FIG. 2, an example coordinate anonymization process 200 performed by the coordinate anonymization module 140 is provided. In a non-limiting example, the process 200 may be performed when the ADAS 102 detects an event, when the vehicle 100 starts, and/or when a request for information is received from the ADAS server 115.

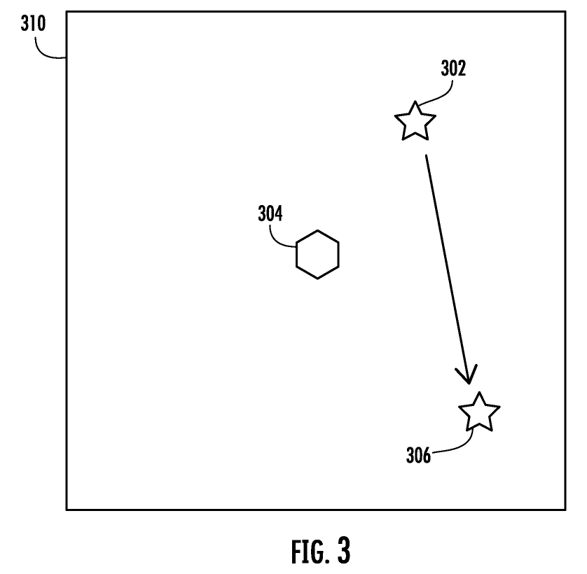

The process 200 performs a distinct location selection 204 to identify location coordinates 206 associated with a distinct location separate from the vehicle 100. For the distinct location selection 204, the coordinate anonymization module 140 is configured to identify or select a distinct location using absolute coordinates 202. In a non-limiting example, using map data from the navigation controller 122. The coordinate anonymization module 140 is configured to identify the distinct location as being a place of interest or lookup point in the vicinity of the vehicle 100 (e.g., a set distance from the vehicle). For example, referring to FIG. 3, using absolute coordinates 302 of the vehicle 100, the coordinate anonymization module 140 identifies a lookup point 304 as the distinct location. Any suitable location may be used as the distinct location, and should not be limited to the example provided herein. For example, the coordinate anonymization module 140 is configured to identify the distinct location as being a predefined longitudinal and latitudinal distance from the vehicle.

With the location coordinates, the coordinate anonymization module 140 performs a vehicle coordinate hashing 208 to obtain ambiguous coordinates 210 having hash coordinate and delta coordinates. That is, the ambiguous coordinates 210 identify a location of the vehicle using a positional relationship between the vehicle 100 and the distinct location. In a non-limiting example, the coordinate anonymization module 140 defines the delta coordinates reflective of X-Y position of the vehicle 100 from the distinct location (e.g., delta coordinates = (∆x, ∆y). In addition, in lieu of using the numerical values of the location coordinates, the coordinate anonymization module 140 employs hash coordinates for the distinct location (e.g., location coordinates (31.657, 31.657) are provided as (#, #)). The ambiguous coordinates 210 for the vehicle is then provided as the location hash coordinates + delta coordinates = ((#+∆x), (#+∆y)).

With continuous reference to FIG. 3, the coordinate anonymization module 140 is configured to update the ambiguous coordinates 210 based on the movement of the vehicle 100. For example, the absolute coordinates 302 is associated with a first position of the vehicle 100 having first delta coordinates (∆x1, ∆y1) and coordinates 306 is associated with a second position of the vehicle 100 having second delta coordinates (∆x2, ∆y2), which may be determined based on movement of the vehicle.

Returning to FIG. 2, using the ambiguous coordinates 210, the coordinate anonymization module 140 performs a map tile selection 212 to obtain an associated map tile 214. In a non-limiting example, when the location of the vehicle 100 is requested (e.g., location requested in response to an ADAS event, in response to a message transmission by the telematics controller 132, etc.), the map tile selection 212 retrieves a map tile associated with the ambiguous coordinates 210 from among a plurality of map tiles stored by the map library 124. For example, in FIG. 3, a map tile 310 is selected for the ambiguous coordinate related to the second position 306 or state more broadly, associated with the ADAS event (position of the vehicle 100 at the time of the ADAS event) or associated with the message request received).

In addition, the coordinate anonymization module 140 is further configured to perform a hash coordinate generalization 216 to define anonymized vehicle coordinates 218. In a non-limiting example, the anonymized vehicle coordinates 218 are represented by the delta coordinates with the hash coordinates being removed (e.g., ((#+∆x), (#+∆y))(∆x, ∆y).

The coordinate anonymization module 140 performs a vehicle location representation 220 to generate an anonymized location data 222 using the associated map tile 214 and the anonymized vehicle coordinates 218. Specifically, in lieu of the absolute coordinates, the location of the vehicle 100 is identified using the map tile and the delta coordinates providing anonymity to the vehicle 100 and its users. In one form, the VLA module 134 provides the anonymized location data 222 to the telematics controller 132, which in return incorporates the data 222 as part of the message to be transmitted. In some variations, the coordinate anonymization module 140 is configured to alter rotation of the coordinate plane by, for example, switching the position of the (x, y) coordinates in the anonymized vehicle coordinates (e.g., delta coordinates (∆x, ∆y) are provided as (∆y, ∆x)).

In some aspects, the VLA module 134 may provide metadata related to the surrounding of the vehicle 100, which may be detected by the sensors 114 or even represented in the map tile. The metadata may be employed by third-parties to detect the actual position of the vehicle, and to inhibit such detection, the location metadata generator 142 is configured to alter a location characteristic that can be used as metadata such that the characteristic may not be used to trace the location of the vehicle 100.

In one form, the location characteristic is associated with an area having the absolute coordinates. For example, the location characteristic may include, but is not limited to: a landmark (e.g., a statue, lakes, mountains, buildings); a curvature of a road upon which the vehicle is traveling; or an identification of the road. The location characteristics may be represented in various sources, such as but not limited to: images from cameras and the map tile.

The location metadata generator 142 is configured to alter information related to the location characteristic of the area to generate an obfuscated characteristic unidentifiable to the area or more specifically to the absolute coordinates of the vehicle 100. In a non-limiting example, the location characteristic may be altered by: modifying a physical characteristic of the landmark (e.g., blurring statue design, adding additional landmarks, changing dimensions of the landmark); changing the curvature of the road (e.g., making a curve along the road shorter); or redacting identification information (e.g., redacting signs, road names, businesses). The VLA module 134 is configured to provide the obfuscated characteristic as part of the anonymized location data.

While specific types of metadata are provided, other suitable information related to the location characteristic may be used. For example, the location characteristics may provide a spatial range associated with the actual position of the vehicle 100, where the spatial range is provided as two-dimensional range (e.g. 1x1mile, 2x2 mile) the obfuscated characteristic in lieu of a distance from a specific point.

In operation, the VLA module 134 is configured to provide anonymized location data for messages based on a request that be initiated from a vehicle system (e.g., the ADAS 102) or an external system (e.g., ADAS server 115). In a non-limiting example, when the ADAS 102 detects an ADAS event that is to be reported to the ADAS server 115, the ADAS 102 requests a message having defined fields to be outputted, where one of the fields includes vehicle location at the time of the ADAS event. The VLA module 134 defines the anonymized location data for the vehicle location field. In some aspects, in addition to the anonymized location data, the message includes vehicle data associated the ADAS event provided by the ADAS 102.

In some aspects, the vehicle data related to the ADAS event may be stored in a vehicle data library 150. With respect to the location of the vehicle 100, the vehicle data library 150 may store the absolute coordinates of the vehicle 100, which may be encrypted. Accordingly, the absolute coordinates are still available and accessible by authorized personal to, for example, verify software updates and/or provide additional precision when analyzing operation of the drive assistance feature related to the ADAS event. In addition to the absolute coordinates, the vehicle data library 150 may also store the anonymized location data 222 associated with the absolute coordinates.

In another example, in addition to or in lieu of waiting for an ADAS event, the ADAS server 115 or other external system may request a status update on the vehicle 100. The vehicle 100 generates and outputs a message including selected vehicle data such as the anonymized location data at the time of receiving the request.

While the VLA module 134 is described in association with transmitting location data for messages related to the ADAS 102, the VLA module 134 of the present disclosure may be incorporated with other suitable systems of the vehicle 100.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

In this application, the term “module” and/or “computing device” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read only circuit), volatile memory circuits (such as a static random access memory circuit or a dynamic random access memory circuit), magnetic storage media (such as an analog or digital magnetic tape or a hard disk drive), and optical storage media (such as a USB, CD, a DVD, or a Blu-ray Disc).

The apparatuses and methods described in this application may be partially or fully implemented by a special purpose computer created by configuring a general-purpose computer (e.g., computing device) to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method, comprising:
defining, by a vehicle system, delta coordinates indicative of positional relationship between a vehicle and a distinct location separate from the vehicle;
converting, by the vehicle system, absolute coordinates of the vehicle to ambiguous coordinates having hash coordinates associated with the distinct location and the delta coordinates;
retrieving, by the vehicle system, a map tile associated with the ambiguous coordinates from among a plurality of map tiles; and
outputting, by the vehicle system, a message including anonymized location data as a location of the vehicle and defined by the map tile and the delta coordinates.

2. The method of claim 1, further comprising identifying, by the vehicle system, the distinct location separate from the vehicle using the absolute coordinates.

3. The method of claim 1, further comprising:
identifying, by the vehicle system, a location characteristic of an area having the absolute coordinates; and
altering, by the vehicle system, information related to the location characteristic of the area to generate an obfuscated characteristic unidentifiable to the area, the anonymized location data being further defined using the obfuscated characteristic.

4. The method of claim 3, wherein the location characteristic includes at least one of, a landmark associated with the map tile, a curvature of a road upon which the vehicle is traveling, or an identification of the road.

5. The method of claim 4, wherein altering information of the location characteristic includes at least one of modifying a physical characteristic of the landmark, changing the curvature of the road, or redacting the identification of the road.

6. The method of claim 1, further comprising updating, by the vehicle system, the delta coordinates based on movement of the vehicle.

7. The method of claim 6, further comprising, in response to an advanced driver assistance system (ADAS) event,
storing, by the vehicle system, data indicative of the absolute coordinates of the vehicle at time of the ADAS event; and
generating, by the vehicle system, vehicle data associated with the ADAS event, wherein the message further includes the vehicle data,
wherein the anonymized location data includes the map tile and the delta coordinates associated with the ADAS event.

8. The method of claim 6, further comprising:
receiving, from a remote server, a vehicle data request, wherein:
the message is outputted to the remote server in response to the vehicle data request and includes at least one vehicle data and the delta coordinates at time of the vehicle data request.

9. A system for a vehicle, comprising:
one or more computing devices configured to:
define delta coordinates indicative of positional relationship between a vehicle and a distinct location separate from the vehicle,
convert absolute coordinates of the vehicle to ambiguous coordinates having hash coordinates associated with the distinct location and the delta coordinates,
retrieve a map tile associated with the ambiguous coordinates from among a plurality of map tiles, and
output a message including anonymized location data as a location of the vehicle and defined by the map tile and the delta coordinates.

10. The system of claim 9, wherein the one or more computing devices are further configured to:
obtain the absolute coordinates using at least one location signal from a satellite network, and
identify the distinct location separate from the vehicle using the absolute coordinates.

11. The system of claim 9, wherein the one or more computing devices are further configured to:
identify a location characteristic of an area having the absolute coordinates, and
alter information related to the location characteristic of the area to generate an obfuscated characteristic unidentifiable to the area, the anonymized location data being further defined using the obfuscated characteristic.

12. The system of claim 11, wherein the location characteristic includes at least one of, a landmark associated with the map tile, a curvature of a road upon which the vehicle is traveling, or an identification of the road.

13. The system of claim 12, wherein to alter information of the location characteristic, the one or more computing devices are further configured to perform at least one of modifying a physical characteristic of the landmark, changing the curvature of the road, or redacting the identification of the road.

14. The system of claim 9, wherein the one or more computing devices are further configured to update the delta coordinates based on movement of the vehicle.

15. The system of claim 14, wherein the one or more computing devices are further configured to, in response to an advanced driver assistance system (ADAS) event:
store data indicative of the absolute location of the vehicle at time of the ADAS event, and
generate vehicle data associated with the ADAS event, wherein the message further includes the vehicle data,
wherein the anonymized location data includes the map tile and the delta coordinates associated with the ADAS event.

16. The system of claim 14, wherein the message is outputted to a remote server in response to a vehicle data request from the remote server and includes at least one vehicle data and the delta coordinates at time of the vehicle data request.

17. A method, comprising:
obtaining, by a vehicle system, absolute coordinates of a vehicle using at least one location signal from a satellite network;
identifying, by the vehicle system, a distinct location separate from the vehicle using the absolute coordinates;
defining, by the vehicle system, delta coordinates indicative of positional relationship between the vehicle and the distinct location;
converting, by the vehicle system, the absolute coordinates of the vehicle to ambiguous coordinates having hash coordinates associated with the distinct location and the delta coordinate;
retrieving, by the vehicle system, a map tile associated with the ambiguous coordinates from among a plurality of map tiles; and
outputting, by the vehicle system, a message including anonymized location data defined by the map tile and the delta coordinates as a location of the vehicle.

18. The method of claim 17, further comprising:
identifying, by the vehicle system, a location characteristic of an area having the absolute coordinates; and
altering, by the vehicle system, information related to the location characteristic of the area to generate an obfuscated characteristic unidentifiable to the area, the anonymized location data being further defined using the obfuscated characteristic.

19. The method of claim 18, wherein:
the location characteristic includes at least one of, a landmark associated with the map tile, a curvature of a road upon which the vehicle is traveling, or an identification of the road, and
the altering information of the location characteristic includes at least one of modifying a physical characteristic of the landmark, changing the curvature of the road, or redacting the identification of the road.

20. The method of claim 17, further comprising, in response to an advanced driver assistance system (ADAS) event,
generating, by the vehicle system, vehicle data associated with the ADAS event, wherein the message further includes the vehicle data; and
storing, by the vehicle system, at least one of the vehicle data and data indicative of the absolute location of the vehicle at time of the ADAS event, wherein the anonymized location data includes the map tile and the delta coordinates associated with the ADAS event.
